(19) United States
(12) Patent Application Publication
(10) Pub. No.: US 2026/0264280 A1
(43) Pub. Date: Sep. 10, 2026

(54) ATTACHMENT FOR A HAIR TRIMMER

(71) Applicant: ARCAVE LIMITED, Solihull (GB)

(72) Inventor: Davinder Singh DHOUPER, Solihull (GB)

(21) Appl. No.: 19/162,942

(22) PCT Filed: Mar. 8, 2023
(86) PCT No.: PCT/IB2023/052187

§ 371 Date: Sep. 7, 2025

(51) Int. Cl. B26B 19/14; B26B 19/38

(52) U.S. Cl. CPC B26B 19/148; B26B 19/3813

(57) ABSTRACT

The invention relates to an attachment (40, 140) for a hair trimmer (10), and in particular an attachment for fitment to an electric trimmer for nasal hair. The hair trimmer has a probe (12; 30) and the attachment has a sleeve (42; 142) configured to surround the probe with a space between the probe and the sleeve. The attachment has a mounting part (60) configured to engage a part of the hair trimmer and to retain the attachment in use. The attachment has at least one opening (46; 146) through which uncut hairs pass to the hair trimmer in use. The attachment can retain and provide a temporary store for hairs which are cut by the hair trimmer.

### FIELD OF THE INVENTION

The invention relates to an attachment for a hair trimmer, and in particular an attachment for fitment to an electric trimmer for nasal hair.

Whilst the attachment is particularly suited for fitment to a hair trimmer for nasal hair, it is expected to be used also for trimming other hair, for example for eyebrows and for hairs in and around the ears. Also, the type of hair trimmer for which the attachment is designed is primarily used for trimming human hair and the following description will relate to such use. Nevertheless, the use of the trimmer and therefore the use of the attachment for trimming animal hair is not excluded.

Directional and orientational terms such as “top”, “bottom” etc. refer to the hair trimmer and attachment in a vertical orientation as represented in FIGS. 1 and 4-6. It will be understood, however, that the hair trimmer, and therefore the attachment, will typically be used in other orientations.

### BACKGROUND TO THE INVENTION

Most hair can be cut manually with scissors in known fashion. However, scissors cannot always effectively cut short hair and other hair cutting devices have been developed. One other type of hair cutting device is generally known as hair clippers. Hair clippers have two generally flat comb-like blades. The blades are often between around 3 cm and 5 cm across. One of the blades is relatively fixed and the other blade is movable and arranged to reciprocate relative to the fixed blade. The blades are in close sliding contact and the side edges of the comb elements are sharpened so that the hair is cut (in a scissor action) as the movable blade slides across the fixed blade and the respective comb elements cross one another. Early hair clippers were manually actuated but many are nowadays electrically actuated.

Electric shavers or razors are another type of hair cutting device, suited to cutting whiskers or other very short hairs. Most shavers have a thin screen behind which is located one or more rotating or reciprocating blades. The screen has holes or slots through which the hairs pass, the hairs being cut (in a scissor action) between the blades and the edges of the holes or slots.

Hair trimmers are another type of hair cutting device and are designed to cut hairs which may not easily be cut by scissors, hair clippers or shavers. Specifically, hair trimmers are primarily designed to cut nasal hair and have a probe which is sized for insertion into a nostril, the probe having one or more blades for cutting hairs growing inside the nostril. The probe can also be moved around the ears and along the eyebrows so that the blade(s) cut hairs in those locations also. Most hair trimmers are electrically actuated and are usually battery-powered.

Hair trimmers are distinguished primarily by the relatively small size of the probe and blade(s). The means by which most designs of hair trimmer cut hair is not unique, and in particular many share features with other types of hair cutting device, albeit of smaller size.

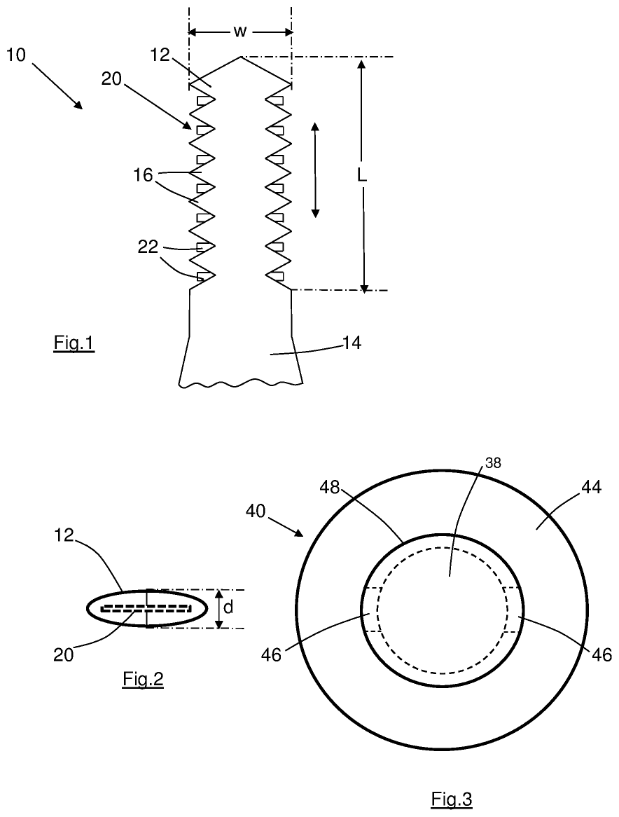

A first type of hair trimmer utilises blades which function similarly to those of a hair clipper, i.e. the probe has a fixed comb-like blade and a relatively movable comb-like blade. The blades and the combs are, however, significantly smaller than those of hair clippers. A part of one example of this type of hair trimmer is shown in FIGS. 1 and 2 and described below.

The hair trimmer 10 has a probe 12 and a body 14. Only a part of the body 14 is shown in FIG. 1 and the body is not shown in FIG. 2. The body 14 will typically contain a battery and a motor connected to the battery (both not shown). The probe 12 is made sufficiently small to readily fit into a user's nostril, for example having a width w of approx. 6 mm and a depth d of approx. 3 mm. The length L of the probe may be approx. 15 mm in a commercial example.

The body 14 will typically be of a size to fit comfortably into a user's hand, for example approximately cylindrical and around 12 cm long and approx. 3 cm in diameter.

The detailed structure, size and shape of the probe and the body differs between manufacturers and models and the hair trimmer 10 shown in FIGS. 1 and 2 is provided as an example to explain the general structure of this first type of hair trimmer.

The probe 12 is formed as a double-sided comb having a number of projecting comb elements 16. The comb elements 16 do not move relative to the body 14 and together form the fixed blade of the hair trimmer 10.

The probe 12 also has a movable blade 20 which is connected to the motor by way of an actuator (not shown), the actuator converting the rotation of the motor into reciprocating movement of the movable blade 20. Thus, in use the movable blade 20 moves reciprocally in the direction of the double-headed arrow relative to the remainder of the probe 12.

The movable blade 20 is also in the form of a double-sided comb with a number of comb elements 22. The movable comb elements 22 are in sliding contact with the fixed comb elements 16 and their cooperating surfaces are sharpened. All of the comb elements 22 move together relative to the remainder of the probe 12 in the direction of the double-headed arrow shown in FIG. 1, with each pair of comb elements 16 and 22 acting to cut hairs in a scissor action.

The movable blade 20 will typically reciprocate over a distance approximately equal to the spacing between adjacent comb elements 22, which usually corresponds to the spacing between adjacent comb elements 16.

Whilst FIG. 1 shows an example of a hair trimmer 10 in which the fixed and movable blades are both double-sided, other examples are single-sided and provide a single row of cooperating comb elements at which hairs are cut. Also, the form of the probe, and the form of the fixed and movable comb elements 16 and 22, vary between different manufacturers and models.

It will be seen that the movable comb elements 22 do not project as far as the fixed comb elements 16. This reduces the likelihood of inadvertent engagement with the movable blade 20 during use. Inadvertent engagement with the movable blade 20 is further reduced by providing a fixed part of the probe to either side of the movable blade (i.e. in front of and behind the movable blade 20 in the orientation as viewed in FIG. 1), as is apparent from FIG. 2.

FIG. 2 shows an end view of the probe 12 with the movable blade 20 shown in dashed outline. As seen, the movable blade 20 is almost totally surrounded by (fixed) parts of the probe 12 in order to reduce or eliminate the likelihood of inadvertent engagement with the movable blade 20 during use. In this example the outer periphery of the probe 12 is curved to reduce any discomfort during use of the hair trimmer, for example inside the nostril.

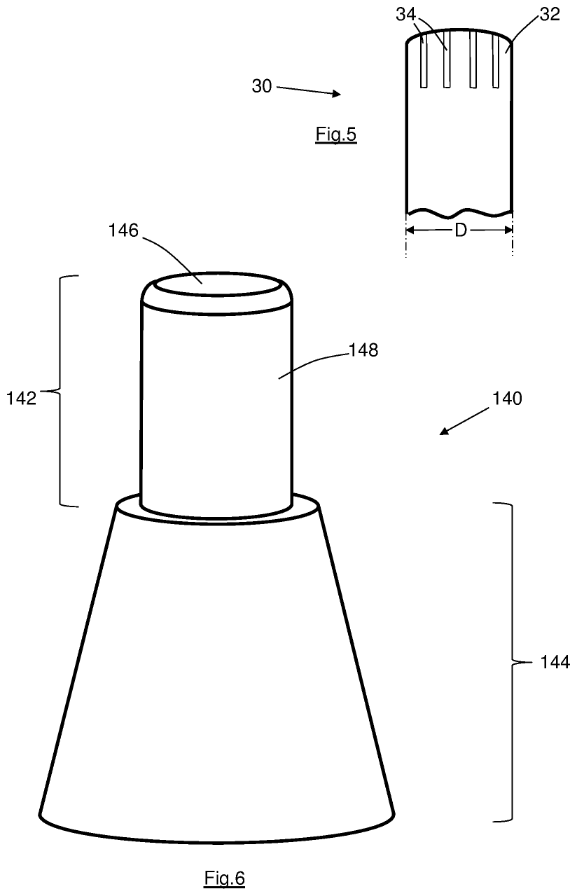

A second type of hair trimmer utilises blades which function similarly to those of a shaver and a part of the probe of an example of this type of hair trimmer is shown in FIG. 5.

The probe 30 shown in FIG. 5 has a cylindrical screen 32 with a number of slots 34 therethrough. The slots are made sufficiently wide to allow hairs to pass therethrough, and in one example are slightly less than 1 mm wide. Though not shown in FIG. 5, a rotating blade or blades are located immediately underneath the screen 32 to cut hairs which pass through the slots 34.

The probe 30 has a diameter D of approx. 7 mm and a length of approx. 10 mm and can therefore fit into a user's nostril. The probe 30 is connected to a body (not shown) which in known fashion contains a motor for rotating the blade(s) and a battery for driving the motor.

The length of the hairs which are cut by the known hair trimmers are very short, of the order of 1 mm for example. The cut hairs are therefore very small and light. The cut hairs will therefore often be drawn further into the nostril if the user is inhaling whilst using the hair trimmer. Notwithstanding their small size the cut hairs can be an irritant inside the nostril, often causing discomfort to the user and dissuading the user from using the hair trimmer. The cut hairs may also be harmful if they are inhaled more deeply into the throat or lungs.

One example of a hair trimmer similar to that of FIG. 5 creates a small airflow into the probe. The primary effect of this airflow is to encourage uncut hairs to enter into the slots of the probe where they can be cut. The airflow might also constrain some of the cut hairs but experience suggests that many of the cut hairs are not captured by the airflow and instead remain in the user's nostril.

### SUMMARY OF THE INVENTION

It is an object of the present invention to provide an attachment for a hair trimmer which can reduce or avoid the likelihood that cut hairs remain in the user's nostril.

According to the present invention there is provided an attachment for a hair trimmer, the hair trimmer having a probe, the attachment having a sleeve configured to surround the probe with a space between the probe and the sleeve, the attachment having at least one opening through which uncut hairs can pass, the attachment having a mounting part which is configured to engage a part of the hair trimmer.

The space between the probe and the sleeve provides a volume adjacent to the blade(s) of the probe which the cut hairs can enter. The cut hairs can remain in that volume until the end of the hair trimming session when the attachment can be removed from the hair trimmer and the cut hairs can be properly disposed of.

Preferably, the sleeve is cylindrical or tubular to fit over the probe. The mounting part may be an interference fit with the hair trimmer to retain the attachment upon the hair trimmer.

Usually the hair trimmer includes a body connected to the probe. Preferably, the sleeve is part of a first portion of the attachment and the attachment also has a second portion, the second portion being configured to surround a part of the body.

Preferably, the mounting part is a part of the second portion. The attachment may be retained on the hair trimmer in use by the mounting part alone whereupon the sleeve plays no part in retaining the attachment and there can be a space between the whole of the sleeve and the probe. Alternatively stated, the sleeve may not engage any part of the probe.

Preferably, the second portion includes a skirt configured to surround the part of the body with a space between the part of the body and the skirt. The space between the part of the body and the skirt provides a second volume. Desirably, the (first) volume between the part of the probe and the sleeve is in communication with the second volume. Such an arrangement allows cut hairs to pass from the first volume to the second volume; the cut hairs can remain in the second volume until the end of the hair trimming session when the attachment can be removed and the cut hairs can be properly disposed of.

Those embodiments having a space between the whole of the sleeve and the probe reduce the likelihood of cut hairs becoming trapped within the sleeve, and thereby increase the likelihood that the cut hairs will pass from the first volume to the second volume.

Preferably, the second volume is larger than the first volume. This arrangement takes advantage of the greater space which is available surrounding the body than surrounding the probe; the majority of the cut hairs can be temporarily retained in the larger second volume until the end of the hair trimming session.

Preferably, the first portion of the attachment is permanently connected to the second portion so that the attachment forms an integrated unit. The first portion has a leading end for insertion into the nostril and a trailing end; preferably the first portion is connected to the second portion at its trailing end. The second portion has a leading end and a trailing end; preferably the leading end is connected to the first portion. The trailing end of the second portion is open for releasable fitment to the hair trimmer.

Preferably the second portion is tapered, the cross-sectional dimension increasing towards the trailing end. Since the body of the hair trimmer will typically also be tapered, and will reduce in cross-sectional dimension towards the probe, such shaping of the attachment can correspond to the shaping of the part of the body of the hair trimmer to which it will be mounted.

It will be understood that there are many different detailed designs of hair trimmer and many different detailed designs of attachment will be required to fit those hair trimmers. It is nevertheless intended that the various designs of attachment will share the same general structure with the minimum of changes to match different hair trimmers.

The hair trimmer may for example be of the first type of hair trimmer described above, in which case the opening of the attachment is preferably located in the sleeve and the leading end of the first portion is preferably closed, ideally by a continuous wall at the leading end of the sleeve. In such embodiments the first portion comprises the sleeve and the continuous end wall. For use with such hair trimmers having a single-sided set of cooperating blades a single opening can be provided, whereas for hair trimmers with a double-sided set of blades two openings can be provided. Ideally the attachment is configured so that the openings overlie some or all of the cooperating blades whereby hairs that pass through the opening(s) can engage the blades directly.

Preferably the side edges of the opening(s) have projections. It has been found that providing projections (teeth) at the edges of the openings enhances the capture of uncut hairs and better guides the uncut hairs through the opening to engage the blades.

Alternatively, the hair trimmer may be of the second type of hair trimmer described above, in which case the opening in the first part of the attachment is preferably located at the leading end of the first portion, preferably comprising an open leading end of the sleeve. In such embodiments the sleeve comprises the whole of the first portion and the leading end of the sleeve is a ring of material surrounding the opening.

Preferably, the sleeve is cylindrical or tubular with a substantially circular cross-sectional shape. The sleeve may have a substantially consistent diameter along its length or it may be tapered from a larger dimension at its trailing end to a smaller dimension at its leading end.

It is necessary that the outer dimension of the sleeve is small enough so that it can be inserted with comfort into a user's nostril. It is also necessary that the inner dimension of the sleeve is large enough to accommodate the probe of the hair trimmer. In one example the sleeve has a substantially circular cross-section with an outer dimension which tapers from approx. 10 mm at its leading end to approx. 12 mm at its trailing end. The sleeve has a wall thickness of approx. 0.75 mm so that the inner dimension tapers from approx. 8.5 mm to approx. 10.5 mm. Such an example can comfortably fit into the nostril of many or all users, and can accommodate a probe with a maximum cross-sectional dimension of approx. 8 mm. It is not necessary that the sleeve is tapered and in some embodiments the cross-sectional dimension of the sleeve will be consistent along its length.

The mounting part is preferably a ring of material at or adjacent to the trailing end of the second portion. The attachment is configured so that the inner edge of the ring of material is sized and shaped to match the outer surface of the part of the body which it will engage. The mounting part can retain the attachment upon the hair trimmer by way of frictional engagement between the ring of material and the body of the hair trimmer. Such a mounting arrangement avoids any requirement to modify the hair trimmer to cooperate with the attachment, and makes the attachment suitable for releasable fitment to existing hair trimmers. Nevertheless, a dedicated mounting means can be provided to permit an attachment to fit to a particular hair trimmer, for example incorporating a spring latch for locating into a dedicated recess of the body of the particular hair trimmer.

Desirably, the mounting part is continuous and closes off the trailing end of the second portion when fitted to the hair trimmer. Such an arrangement encloses the second volume and helps to retain cut hairs in the second volume between the skirt and the body of the hair trimmer until the attachment is removed and the cut hairs can be properly disposed of.

### BRIEF DESCRIPTION OF THE PREFERRED EMBODIMENTS

The invention will now be described in more detail, by way of example, with reference to the accompanying drawings, in which:

FIG. 1 shows the probe and part of the body of a first type of hair trimmer;

FIG. 2 shows an end view of the probe of FIG. 1;

FIG. 3 shows a top view of an attachment configured to fit the hair trimmer of FIGS. 1 and 2;

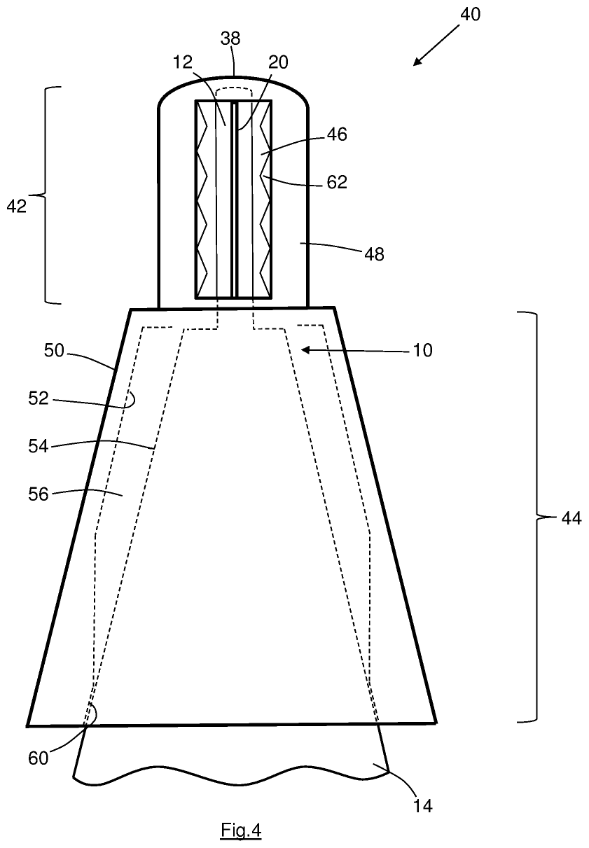

FIG. 4 shows a side view of the attachment of FIG. 3, fitted to a first type of hair trimmer (the hidden parts of the hair trimmer are shown in dashed outline);

FIG. 5 shows part of the probe of a second type of hair trimmer; and

FIG. 6 shows a perspective side view of an attachment configured to fit the hair trimmer of FIG. 5.

### DETAILED DESCRIPTION

The hair trimmer of FIGS. 1 and 2 is described above and that description will not be repeated.

A first embodiment of an attachment 40 according to the present invention is shown in FIGS. 3 and 4. The attachment has a first portion 42 including a sleeve 48 which is configured to surround the probe 12, and a second portion 44 including a skirt 50 which is configured to surround a part of the body 14. The sleeve 48 has an opening 46 which is large enough to allow uncut hairs to pass therethrough.

In particular, it will be understood that when the attachment 40 is fitted to the hair trimmer 10 as shown in FIG. 4, and the hair trimmer is used to cut nasal hair, the leading end of the probe 12 and fitted attachment 40 (i.e. the top as viewed in FIG. 4) are inserted into the nostril and manipulated so that uncut hairs pass through the opening 46, engage the probe 12 and are cut by the blade 20.

It is arranged that the opening 46 is aligned with the movable blade 20 as shown in FIG. 4. Also, the sleeve 48 is only slightly larger than the probe 12 so that the blade 20 lies relatively close to the opening 46 and the hairs can be cut relatively close to their root.

As will be understood from FIGS. 2 and 3, the circular cross-sectional shape of the sleeve 48 does not match the oval cross-sectional shape of the probe 12. The circular internal shape of the sleeve 48 is shown in dashed outline in FIG. 3 since it is not visible through the continuous wall 38 at the leading end. The different shaping of the sleeve 48 is deliberate so that a space is provided between the probe 12 and the sleeve 48, the space providing a first volume inside the attachment 40. In use, hairs which are cut by the blade 20 are retained in the first volume with few if any of the cut hairs passing back out of the opening 46.

The skirt 50 is generally hollow and is of an internal size and shape to accommodate the part of the body 14 adjacent to the probe 12. Importantly, the skirt 50 is sufficiently large to provide a space between the part of the body and the skirt. In FIG. 4 the internal surface of the skirt 50 is represented by the dashed lines 52 and the external surface of the body 14 is represented by the dashed lines 54, with a second volume 56 between those surfaces.

The trailing end of the sleeve 48 (i.e. the bottom end as viewed in FIG. 4) is permanently connected to the leading end of the skirt 50 (i.e. the top end as viewed in FIG. 4). The first volume is in communication with the second volume 56 whereupon cut hairs can pass from the first volume into the second volume 56 where they are retained until the attachment 40 is removed. The second volume 56 is significantly larger than the first volume, the attachment 40 taking advantage of the relatively greater space which is available around the body 14 of the hair trimmer.

The second portion 44 of the attachment 40 has a mounting part 60 at its trailing end, which mounting part 60 is configured to engage the body as represented in FIG. 4 (a small gap is shown in FIG. 4 for clarity but in practice the mounting part will engage the body 14). In particular, the wall of the skirt 50 is made thicker at the trailing end so that its internal size and shape closely matches that of the relevant part of the body 14. In this embodiment the mounting part 60 forms an interference fit with the body 14 and the attachment 40 is retained by friction. It will be understood that further means to retain the attachment, such as spring clips or latches for example, can be used in other embodiments.

Importantly, the mounting part 60 forms a complete ring surrounding and engaging the body 14 so that none of the cut hairs can escape from the second portion 44 of the attachment 40 until it is removed, at which time the cut hairs can properly be disposed of.

It will be understood that the second portion 44 is optional and in other embodiments the attachment can comprise only the sleeve 42, a part of the sleeve being an interference fit with a part of the probe whereby to retain the attachment to the probe by friction. Embodiments having a second portion 44 are preferred, however, as they can provide a larger volume in which cut hairs can be stored, and provide more freedom for the location of the mounting part.

As shown in FIG. 3, the attachment 40 is of circular cross-section. The sleeve 48 is of cylindrical or tubular form with a consistent diameter and wall thickness (apart from the opening 46) along its length. The outer wall of the skirt 50 has a consistent taper angle along its length. In practice, the attachment will be sized and shaped to match the body 14 and probe 12 of the hair trimmer it is designed to fit. In particular, the sleeve 48 will have an internal dimension and a length suited to the probe 12 and the second portion 44 will have a shape and size suited to provide a clearance surrounding the part of the body 14 and the required engagement at the mounting part 60.

In an alternative embodiment to that of FIGS. 3 and 4, some or all of the first portion could for example be non-circular to more closely match the oval shape of the probe 12, although there must be some clearance to provide the necessary (first) volume around the probe.

It will be understood that an attachment with a circular cross-section through its length can be fitted to the hair trimmer at any orientation. In other words the attachment 40 can be rotated as viewed in FIG. 3 to a position in which the opening 46 in the sleeve 48 is not aligned with the blade 20. That is not desirable as the hair trimmer will be most effective if the opening 46 is aligned with the blade 20, so that the opening 46 directly overlies the blade 20 and the uncut hairs have the smallest gap to cross before engaging the blade 20. Accordingly, it may be necessary to ensure that the attachment can only be fitted in an orientation in which the opening 46 is aligned with the blade 20. In practice, the body of the hair trimmer will not likely have a circular cross-section throughout and the orientation of the attachment 40, and therefore the location of the opening 46, will be determined by the correspondingly non-circular mounting part 60.

It will be understood that because the hair trimmer 10 has a double-sided blade 20 the attachment 40 has two openings 46 as shown in dashed outline in FIG. 3.

FIG. 4 shows the projections or teeth 62 which are located at the edges of the opening 46. It has been found that such teeth better capture uncut hairs and therefore better ensure that those hairs pass through the opening 46 and are cut by the hair trimmer 10.

A second embodiment of attachment 140 according to the present invention is shown in FIG. 6. The attachment 140 is suited for fitment to the second type of hair trimmer 30 shown in FIG. 5.

The attachment 140 is generally similar to the attachment 40 and the common parts (or at least the parts fulfilling the same function) will not be described again.

Importantly, whereas the leading end of the first portion 42 of the attachment 40 is closed and the openings 46 are formed through the sleeve 48, in the attachment 140 the opening 146 is at the leading end of the sleeve 148, i.e. the leading end wall is removed. The sleeve 148 is continuous and has a curved leading end for added comfort in use.

It will be understood that when the attachment 140 is fitted to the hair trimmer 30 and the hair trimmer is used to cut nasal hair, the leading end of the probe and fitted attachment are inserted into the nostril and manipulated so that uncut hairs pass firstly through the opening 146, pass secondly through one of the slots 34 in the screen 32, and are cut by the blade within the probe 30.

The second portion 144 of the attachment 140 is similar to the second portion 44 of the attachment 40, and is mounted to the hair trimmer in a similar fashion. It will be understood, however, that the possible variations described for the attachment 40 apply similarly to the attachment 140.

Whilst the attachment 40 is suited for use with a hair trimmer of the first type described above, and the attachment 140 is suited for use with a hair trimmer of the second type described above, the use of the attachments is not restricted to those types of hair trimmer. For example, the attachment 40 could be used with the hair trimmer 30 and the attachment 140 could be used with the hair trimmer 10, if desired (albeit with an expected reduction in performance).

1. An attachment for a nasal hair trimmer, the nasal hair trimmer having a probe configured for insertion into a user's nostril, the attachment having a sleeve configured to surround the probe with a space between the probe and the sleeve, the sleeve also being configured for insertion into the user's nostril. the attachment having a mounting part configured to engage a part of the hair trimmer, the attachment having at least one opening through which uncut hairs can pass in use to be cut by the hair trimmer.

2. The attachment according to claim 1 in which the sleeve is cylindrical.

3. The attachment according to claim 1 in which the mounting part has an inner edge which is configured to match the outer surface of the part of the hair trimmer.

4. The attachment according to claim 1 in which the mounting part is a continuous ring.

5. The attachment according to claim 1 in which the mounting part is an interference fit to the part of the hair trimmer.

6. The attachment according to claim 1 in which the sleeve is part or all of a first portion of the attachment, in which the hair trimmer has a body connected to the probe, and in which the attachment has a second portion configured to surround a part of the body.

7. The attachment according to claim 6 in which the mounting part is a part of the second portion.

8. The attachment according to claim 6 in which there is a space between the whole of the probe and the sleeve in use.

9. The attachment according to claim 1 in which the second portion includes a skirt configured to surround the part of the body with a space between the part of the body and the skirt.

10. The attachment according to claim 9 in which, in use, the space between the probe and the sleeve provides a first volume and the space between the part of the body and the skirt provides a second volume.

11. The attachment according to claim 10 in which the first volume is in communication with the second volume.

12. The attachment according to claim 10 in which the second volume is larger than the first volume.

13. The attachment according to claim 6 in which the first portion is permanently connected to the second portion.

14. The attachment according to claim 13 in which the first portion has a leading end and a trailing end and in which the second portion is connected at the trailing end of the first portion.

15. The attachment according to claim 13 in which the second portion has a leading end and a trailing end and in which the first portion is connected at the leading end of the second portion.

16. The attachment according to claim 6 in which the second portion is tapered.

17. The attachment according to claim 16 in which the cross-sectional dimension of the second portion increases towards the trailing end.

18. The attachment according to claim 1 in which the opening is formed in the sleeve.

19. The attachment according to claim 18 in which the sleeve has a continuous wall at its leading end.

20. The attachment according to claim 18 in which the opening has a number of projections.

21. The attachment according to claim 20 in which the opening has opposing side edges, and in which the number of projections is located at one of the side edges.

22. The attachment according to claim 21 in which the number of projections is located at both of the side edges.

23. The attachment according to claim 18 having two openings.

24. The attachment according to claim 1 in which the opening is at the leading end of the sleeve.

25. The attachment according to claim 24 in which the leading end of the sleeve is a ring surrounding the opening.
